(19) United States
(12) Patent Application Publication
(10) Pub. No.: US 2026/0288071 A1
(43) Pub. Date: Sep. 24, 2026

(54) CASING FRAME, TIMEPIECE, AND CASE BODY

(71) Applicant: CASIO COMPUTER CO., LTD., Tokyo (JP)

(72) Inventor: Yuya ARIMORI, Tokyo (JP)

(21) Appl. No.: 19/575,346

(22) Filed: Mar. 23, 2026

(30) Foreign Application Priority Data
Mar. 24, 2025 (JP) 2025-048406

(51) Int. Cl. G04B 37/00

(52) U.S. Cl. CPC G04B 37/0008

(57) ABSTRACT

A casing frame accommodatable within a case body includes: a bottom plate; a side wall erected from a peripheral edge of the bottom plate; and a locking portion formed on an outer peripheral side of the side wall, the locking portion being lockable to an engagement portion formed on an inner peripheral surface of the case body. When the locking portion is locked to the engagement portion, at least a portion of the locking portion protrudes obliquely relative to the inner peripheral surface of the case body and toward the inner peripheral surface of the case body.

### CROSS-REFERENCE TO RELATED APPLICATION

This application claims priority and benefit of Japanese Patent Application No. 2025-048406, filed on March 24, 2025. The entire disclosure of Japanese Patent Application No. 2025-048406, filed on March 24, 2025, including description, claims, drawings and abstract is incorporated herein by reference.

### BACKGROUND OF THE INVENTION

### Technical Field

The present invention relates to a casing frame, a timepiece, and a case body.

### Description of Related Art

Conventionally, a configuration is known where a casing frame that houses a module is accommodated within a case body. The module includes components such as button batteries. If a user can easily remove the casing frame by hand, the batteries and other components may also come loose. This creates a risk of accidental battery ingestion or loss by the user. In this regard, for example, Japanese Unexamined Utility Model (Registration) Application Publication No. 62-184490 describes a configuration where the module (referred to as the movement in Japanese Unexamined Utility Model (Registration) Application Publication No. 62-184490) is fixed to the case body by a hook, preventing the user from easily removing the module.

### SUMMARY OF THE INVENTION

A casing frame reflecting one aspect of the present invention is accommodatable within a case body and comprises: a bottom plate; a side wall erected from a peripheral edge of the bottom plate; and a locking portion formed on an outer peripheral side of the side wall, the locking portion being lockable to an engagement portion formed on an inner peripheral surface of the case body, wherein, when the locking portion is locked to the engagement portion, at least a portion of the locking portion protrudes obliquely relative to the inner peripheral surface of the case body and toward the inner peripheral surface of the case body.

### BRIEF DESCRIPTION OF DRAWINGS

The accompanying drawings are not intended as a definition of the limits of the invention but illustrate embodiments of the invention, and, together with the general description given above and the detailed description of the embodiments given below, serve to explain the principles of the invention, wherein:

FIG. 1 is a front view of a timepiece according to an embodiment;

FIG. 2 is a plan view of the back surface side of the timepiece with an exterior member removed from the state illustrated in FIG. 1;

FIG. 3 is a cross-sectional view taken along line III-III shown in FIG. 2;

FIG. 4 is a perspective view of a case body according to the embodiment as seen from the back surface side;

FIG. 5 is a perspective view of a casing frame according to the embodiment as seen from the back surface side;

FIG. 6 is an enlarged plan view of the casing frame according to the embodiment as seen from the front surface side;

FIG. 7 is an enlarged plan view of a major portion of a locking portion and its surrounding region in FIG. 2 as seen from the back surface side;

FIG. 8 is a cross-sectional view of a major portion illustrating a process of removing the casing frame according to the embodiment from the case body using a jig; and

FIG. 9 is a cross-sectional view of a major portion illustrating the process of removing the casing frame according to the embodiment from the case body using the jig.

### DETAILED DESCRIPTION

With reference to the drawings, an embodiment of a casing frame 5 according to the present invention and a timepiece including the casing frame 5 will be described. The following embodiment illustrates an example where the casing frame 5 is applied to a wristwatch (hereinafter referred to as "timepiece 100") worn on the wrist. In the following description, the X-direction refers to the 3 o'clock to 9 o'clock direction on an analog timepiece, and the Y-direction refers to the 12 o'clock to 6 o'clock direction. The Z direction is defined as the thickness direction (up-down direction) of the timepiece 100. In the Z-direction, the front side, which is the visible side, is referred to as the "upper side (front surface side)", and the back side is referred to as the "lower side (back surface side)". Furthermore, the direction perpendicular to the central axis (not shown) of a case body 1 along the up-down direction is referred to as the "radial direction". The direction of rotation about the central axis is referred to as the "circumferential direction". Within the plane perpendicular to the central axis, the side closer to the central axis is referred to as the "inner side (inner diameter side)", and the side farther from the central axis is referred to as the "outer side (outer diameter side)". The embodiment described below is provided with various limitations technically preferable for carrying out the present invention. However, the scope of the present invention is not limited to the embodiment below or illustrated examples.

As illustrated in FIG. 2 and other figures, the timepiece 100 according to the present embodiment includes the case body 1 and the casing frame 5 that is accommodatable within the case body 1. In the embodiment, the case body 1 is formed of various metallic materials such as stainless steel (SUS) or titanium. The material forming the case body 1 is not particularly limited. The case body 1 needs only to be formed of a material of a certain degree of rigidity and may be formed of materials other than those illustrated. For example, the case body 1 may be formed of hard synthetic resins such as super engineering plastics like polyarylate (PAR) or engineering plastics like polyacetal (POM).

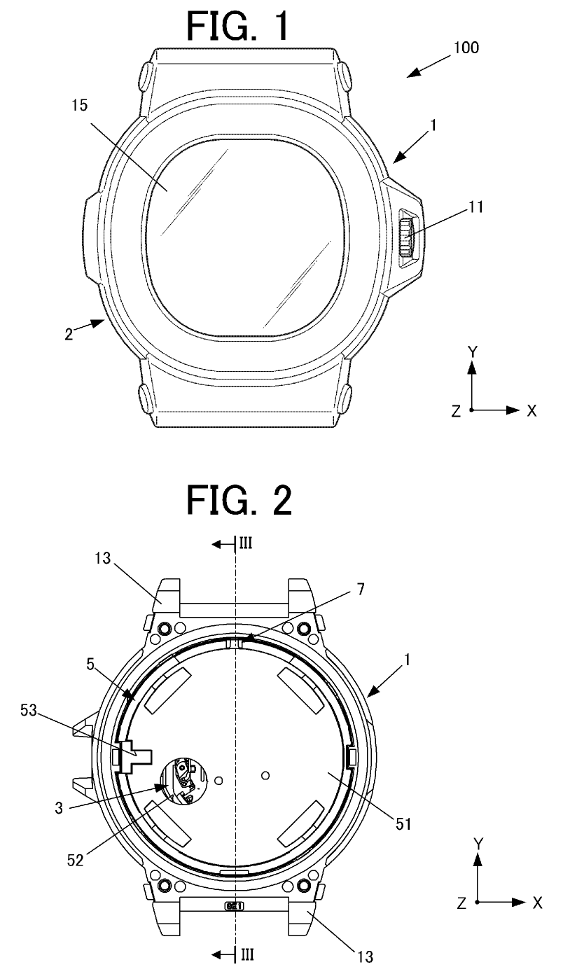

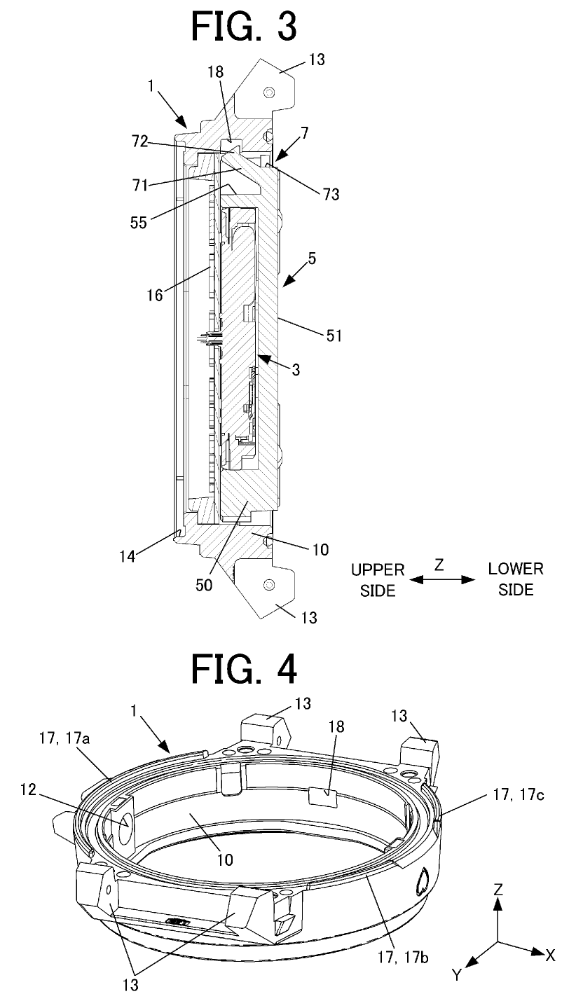

The case body 1 is formed as a cylinder along the Z-direction, which is the thickness direction of the timepiece 100, and has a hollow short-column shape with openings at the top and bottom in the Z-direction. The cylindrical portion of the case body 1 is referred to as a peripheral wall 10. An operating element 11, such as a crown or a push button, is provided on the outer periphery of the case body 1 (peripheral wall 10) for a user to perform various input operations. For example, the operating element 11 is provided on the outer side of the peripheral wall 10, on the 3 o'clock or 9 o'clock side of an analog timepiece. In the example illustrated in FIG. 1, a crown is provided as the operating element 11 on the 3 o'clock side of an analog timepiece. A through hole 12 (see FIG. 4) is formed in the peripheral wall 10 at a position corresponding to the shaft portion (so-called winding stem) of the crown, penetrating the case body 1. Furthermore, in the embodiment, an engagement portion 18 that locks the casing frame 5 is formed on the inner peripheral surface of the case body 1 (the inner-side surface of the peripheral wall 10) on the 12 o'clock side of an analog timepiece (see FIG. 4). As illustrated in FIG. 3 and other figures, in the embodiment, the engagement portion 18 is a recess having a substantially U-shaped cross-section. Furthermore, band attachment portions 13 are provided on the outer side of the case body 1, on both sides in the Y-direction (12 o'clock to 6 o'clock direction). The band attachment portions 13 are portions that connect a band (not shown) to the case body 1.

A watch glass 15 (see FIG. 1) is attached to an opening 14 (see FIG. 2, etc.) on the upper side (the upper side in the Z-direction, the visible side on the timepiece, the front surface side) of the case body 1 to close the opening 14. The watch glass 15 is a transparent member (cover member) formed, for example, of glass material or transparent resin material. Furthermore, an opening on the lower side (the lower side in the Z direction, the back surface side of the timepiece 100) of the case body 1 is closed with a back cover (not shown). It is preferable that the watch glass 15 and the back cover are attached via a waterproof ring or the like. By interposing a waterproof ring or the like between the watch glass 15 or the back cover and the case body 1, the upper and lower openings of the case body 1 are sealed in an airtight state. Furthermore, in the embodiment, an exterior member 2 formed of resin or the like is provided on the outer side of the case body 1. The exterior member 2 is provided to cover at least the upper side and the side surface of the case body 1. Note that providing the exterior member 2 on the outer side of the case body 1 is not essential. The exterior member 2 is omitted from the drawings in FIG. 2 and subsequent figures. Note that FIG. 1 and other figures schematically illustrate the timepiece 100 and do not accurately depict specific shapes or configurations.

Various components, such as a module 3, are accommodated within a hollow portion (the space inside the peripheral wall 10) of the case body 1, while they are housed within the casing frame 5. Although the specific configuration of the module 3 is not detailed, when the timepiece 100 is an electronic timepiece, the module 3 includes various operational components of the timepiece 100, a controller controlling these components, a battery, and the like. The battery is, for example, a button battery. The timepiece 100 may include an analog display, such as one with hands (not shown), or a digital display, such as an LCD display. When the timepiece 100 includes a crown as the operating element 11 as illustrated in the example, the shaft portion (winding stem) of the crown is inserted through the through hole 12 provided in the case body 1, passing from the outside of the case body 1 into the module 3 accommodated within the case body 1. Furthermore, components such as a dial 16 are disposed on the upper side (visible side) of the module 3 in the Z-direction.

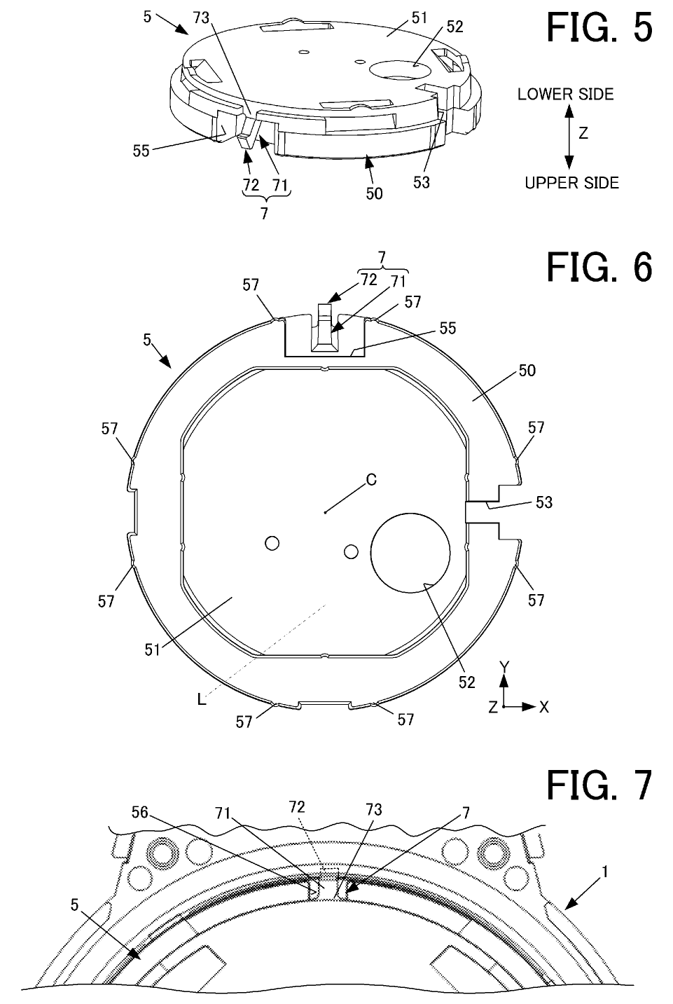

The casing frame 5 is formed, for example, of various resins and is accommodatable within the case body 1 as described above. The casing frame 5 includes a bottom plate 51 and a side wall 50 erected from the peripheral edge of the bottom plate 51, forming a case with a substantially short column shape that is open on the upper side of the side wall 50 in the Z-direction. The bottom plate 51 of the embodiment is formed in a substantially disc shape, and a hole 52 penetrating in the thickness direction (Z-direction) is provided in a portion of the bottom plate 51. The position and size of the hole 52 are not limited to the illustrated example. Furthermore, as illustrated in FIGS. 5 and 6, the side wall 50 in the embodiment is a continuous upright wall that rises from substantially the entire periphery of the bottom plate 51. Note that the side wall 50 is not limited to being continuous. For example, the side wall 50 may be divided into several sections along the circumferential direction of the bottom plate 51. Furthermore, the side wall 50 may partially have a notched portion. In the embodiment, as illustrated in FIGS. 5 and 6, a notched portion 53 is formed in a portion of the side wall 50 of the casing frame 5 (on the 3 o'clock side corresponding to the crown) to avoid the shaft portion (winding stem) of the crown. This allows the casing frame 5 to be removed without removing the shaft portion.

The casing frame 5 of the embodiment has a locking portion 7 that is locked to the case body 1, for example, on the 12 o’clock side of an analog timepiece. The locking portion 7 is provided, for example, on the outer peripheral side of the side wall 50, at a position corresponding to the engagement portion 18 formed on the inner peripheral surface of the aforementioned case body 1 (the inner-side surface of the peripheral wall 10). The locking portion 7 of the casing frame 5 includes an arm portion 71 extending from the bottom plate 51 and a hook-shaped portion 72 formed at the free end of the arm portion 71. At least the arm portion 71 is elastically deformable. When the hook-shaped portion 72 is locked within the recessed engagement portion 18, substantially the entire structure of the locking portion 7 protrudes obliquely relative to the inner peripheral surface of the case body 1 (inner-side surface of the peripheral wall 10). That is, the arm portion 71 has springiness, urging the hook-shaped portion 72 to open toward the outer side of the casing frame 5. This ensures that once the hook-shaped portion 72 is locked to the engagement portion 18, the locked state is maintained. Furthermore, a portion of the side wall 50 on the 12 o'clock side, specifically including a region that surrounds the locking portion 7, forms a first recess 55 that is recessed toward the inner periphery. The formation of the first recess 55 ensures that a space extending toward the inner periphery of the side wall 50 is provided at the locking portion 7, as illustrated in FIG. 3 and other figures.

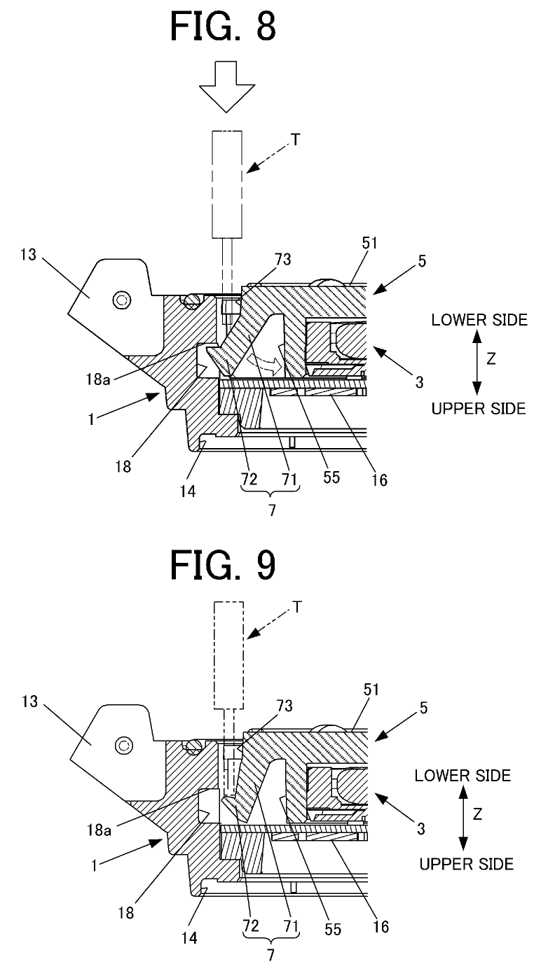

Furthermore, as illustrated in FIG. 3 and other figures, in the embodiment, a portion at the base end of the arm portion 71 is a straight portion 73 formed linearly along the inner peripheral surface of the case body 1 (inner-side surface of the peripheral wall 10). Specifically, the arm portion 71 has a portion, at the base end, that extends from the bottom plate 51 as the straight portion 73, which rises toward the upper side in the Z-direction. The free end portion of the arm portion 71 beyond the straight portion 73 protrudes obliquely toward the inner peripheral surface of the case body 1. As a result, at the base end of the arm portion 71 (locking portion 7), a gap is secured between the inner peripheral surface of the case body 1 (the inner-side surface of the peripheral wall 10) and the locking portion 7 (the straight portion 73 of the arm portion 71). Therefore, when a jig T (see FIG. 8), such as a screwdriver, is to be inserted, the tip of the jig T can be inserted through this gap.

Furthermore, in this state where the locking portion 7 is locked to the engagement portion 18 (locked state), at least a portion of the locking portion 7 does not overlap with the bottom plate 51 and side wall 50 in plan view. Specifically, as illustrated enlarged in FIG. 7, in this locked state in the embodiment, the base end of the arm portion 71 does not overlap with the bottom plate 51. Furthermore, since the free end portion of the arm portion 71 protrudes obliquely toward the peripheral wall 10, the base end of the arm portion 71 does not overlap beneath the side wall 50. Thus, at least a portion of the locking portion 7 (in the embodiment, the base end of the arm portion 71) does not overlap with the bottom plate 51 and side wall 50 when viewed in plan from the back surface side. Consequently, the jig T can be inserted smoothly without catching on the side wall 50 and the like, when inserted from the back surface side, allowing the locking portion 7 to be pressed. This allows the locked state, in which the hook-shaped portion 72 is locked to the engagement portion 18, to be released. Furthermore, in the embodiment, a second recess 56 (see FIG. 7) is formed on the bottom plate 51 side of the side wall 50. The locking portion 7 extends from this second recess 56. Therefore, a gap is secured between the peripheral wall 10 of the case body 1 and the base end of the locking portion 7. Consequently, when the casing frame 5 needs to be removed, the jig T can be smoothly inserted into this gap to release the locked state of the locking portion 7.

Furthermore, in the embodiment, the side wall 50 has protrusions 57 extending radially outward from the bottom plate 51. Each of the protrusions 57 is a compressible dowel. The casing frame 5 is press-fitted and fixed to the case body 1. When the casing frame 5 is press-fitted to the case body 1, the protrusions 57 are compressed and crushed while being press-fitted. This ensures that the casing frame 5 is securely press-fitted and fixed to the case body 1. Furthermore, in the embodiment, it is preferable that the protrusions 57 are positioned substantially symmetrically with respect to an imaginary straight line L connecting the locking portion 7 and the center of the bottom plate 51 (the center point C in FIG. 6). The casing frame 5 is pressed firmly against the case body 1 in the regions where the protrusions 57 are provided. Therefore, when the positions of the protrusions 57 are skewed left or right in the X-direction, the casing frame 5 is tightly held in the regions with more protrusions 57 but prone to lifting away from the case body 1 in the regions with fewer protrusions. Thus, when the forces applied to the case body 1 are uneven, it becomes difficult to smoothly remove the casing frame 5. In particular, near the regions where forces are applied to remove the casing frame 5 from the case body 1, it is preferable to distribute the forces required to release the hook-shaped portion 72 so that the forces are not biased in any particular direction.

In this regard, for example, in the example illustrated in FIG. 6, around the locking portion 7, which is the region where forces are applied to remove the casing frame 5 from the case body 1, protrusions 57 are provided on both sides of the locking portion 7 (imaginary straight line L) in the X direction, effectively preventing force imbalance. Similarly, on the 6 o'clock side of an analog timepiece, protrusions 57 are provided on both sides of the imaginary straight line L in the X-direction. Furthermore, two protrusions 57 are provided on each of the 3 o'clock and the 9 o'clock sides of an analog timepiece. Thus, by positioning the protrusions 57 at substantially symmetrical locations with respect to the imaginary straight line L, the forces applied to the case body 1 and the casing frame 5 during removal of the casing frame 5 from the case body 1 are not biased. This allows the forces applied to the case body 1 and the casing frame 5 to be as evenly distributed as possible.

Next, the operation of the casing frame 5 according to the present embodiment and the timepiece 100 including the casing frame 5 will be described. When the timepiece 100 according to the embodiment is assembled, the module 3 is housed within the casing frame 5. In this step, the position where the shaft portion of the operating element 11 (e.g., the winding stem of the crown) is to be inserted is aligned with the position of the notched portion 53 of the casing frame 5. Then, the opening 14 on the upper side (upper side in the Z direction, front surface side, visible side) of the case body 1 is closed with the watch glass 15, and the casing frame 5, with the module 3 housed inside, is placed within the case body 1. In this step, the orientation is adjusted so that the position of the notched portion 53 of the casing frame 5 corresponds to the position of the through hole 12 in the case body 1. Furthermore, the locking portion 7 is adjusted and positioned so as to be disposed on the 12 o'clock side of an analog timepiece.

When the casing frame 5 is press-fitted into the case body 1, the protrusions 57 of the casing frame 5 are compressed by the inner peripheral surface of the case body 1 (the inner-side surface of the peripheral wall 10), and the casing frame 5 is press-fitted and fixed within the case body 1. Furthermore, although the locking portion 7 (at least the hook-shaped portion 72) protrudes outward beyond the inner peripheral surface of the case body 1, the spring-elastic arm portion 71 is pressed by the inner peripheral surface of the case body 1 and deflects, moving back the hook-shaped portion 72 up to the inner peripheral surface of the case body 1. When the hook-shaped portion 72 reaches the position of the recessed engagement portion 18, the hook-shaped portion 72 protrudes into the engagement portion 18. This causes the hook-shaped portion 72 of the locking portion 7 and the engagement portion 18 of the case body 1 to be fitted to each other, preventing separation (see FIGS. 3 and 8). Subsequently, the shaft portion of the operating element 11 (e.g., the winding stem of the crown) is inserted through the through hole 12 from the outside of the case body 1 and inserted into the module 3 housed within the casing frame 5. Furthermore, the opening on the lower side (lower side in the Z direction, back surface side, non-visible side) of the case body 1 is closed with the back cover. This completes the timepiece 100.

When it is desired to remove the casing frame 5 from the case body 1 for repairs or other purposes, the back cover is first removed from the bottom side (the lower side in the Z direction, the back surface side) of the case body 1. Then, as illustrated in FIG. 8, the jig T, such as a screwdriver, is inserted between the locking portion 7 on the 12 o'clock side of the timepiece and the case body 1 to press the arm portion 71 of the locking portion 7. The arm portion 71 protrudes obliquely outward from the outer-side surface of the casing frame 5, thereby forming an inclined surface. When the arm portion 71 is pressed by the jig T, the arm portion 71 undergoes elastic deformation, deflecting the locking portion 7 away from the inner peripheral surface of the case body 1. As indicated by the white-filled arrow in FIG. 8, the locking portion 7 then tilts inward toward the casing frame 5. The presence of the first recess 55 in the side wall 50 ensures that a space extending toward the inner periphery of the side wall 50 is provided at the locking portion 7. When the arm portion 71 is pressed by the jig T, the locking portion 7 can tilt into this space. This allows the hook-shaped portion 72 of the locking portion 7 to be released from the engagement portion 18 of the case body 1, as illustrated in FIG. 9, enabling the casing frame 5 to be removed.

The module 3 housed within the casing frame 5 is also press-fitted to some extent. Therefore, attempting to remove only the casing frame 5 from the case body 1 could damage the module 3, or, particularly, place excessive stress on a shaft member, such as the winding stem inserted into the module 3 from the outside, potentially causing damage. In this regard, the casing frame 5 of the embodiment has the hole 52 formed in the bottom plate 51, and as illustrated in FIG. 2, a portion of the internal module 3 is exposed through this hole 52. Therefore, when the casing frame 5 is removed, a finger or the like is inserted through this hole 52 to hold down the module 3 during the operation. This prevents the module 3 from being pulled out of the case body 1 together with the casing frame 5. Furthermore, in the embodiment, as described above, the protrusions 57 are provided at positions substantially symmetrical with respect to the imaginary straight line L connecting the locking portion 7 and the center of the bottom plate 51 (center point C in FIG. 6). Therefore, even when a load is applied to the casing frame 5 or the case body 1 during removal of the casing frame 5 from the case body 1, the load is dispersed rather than concentrated on a single portion of the case body 1. This prevents damage to the casing frame 5 and other components.

Next, the effects of the casing frame 5 according to the embodiment and the timepiece 100 including the casing frame 5 will be described. The casing frame 5 according to the embodiment includes the bottom plate 51 and the side wall 50 erected from the peripheral edge of the bottom plate 51 and is accommodatable within the case body 1. The casing frame 5 has the locking portion 7 on the outer peripheral side of the side wall 50. The locking portion 7 is lockable to the engagement portion 18 formed on the inner peripheral surface of the peripheral wall 10, which is the inner peripheral surface of the case body 1. When locked to the engagement portion 18, the locking portion 7 protrudes obliquely relative to the inner peripheral surface of the case body 1. If simple manual removal of the module from the case body is possible, such as by hooking a finger, there is a risk that a child could remove the casing frame 5 and accidentally swallow or lose batteries (e.g., button batteries) or various components contained within the module. In this regard, the configuration of the embodiment makes it difficult to remove the casing frame 5 from the case body 1 by hand, thereby avoiding such risks. On the other hand, removal of the casing frame is necessary for repairs or other purposes. However, in conventional configurations, such as those described in Japanese Unexamined Utility Model (Registration) Application Publication No. 62-184490, removing the module is difficult even with jigs, posing a risk of damaging the module or its surrounding components during removal of the module. In contrast, the configuration of the embodiment allows the casing frame 5 to be removed from the case body 1 by releasing the locking portion 7, which protrudes obliquely relative to the inner peripheral surface of the case body 1, from the engagement portion 18 using the jig T or a similar tool. Therefore, the casing frame 5 can be smoothly removed using a jig during repairs or similar operations.

Furthermore, the locking portion 7 of the embodiment includes the arm portion 71 extending from the bottom plate 51 and the hook-shaped portion 72 formed at the free end of the arm portion 71. At least the arm portion 71 is elastically deformable. The locking portion 7 protrudes outward beyond the inner peripheral surface of the case body 1 but can be accommodated within the case body 1 by deflection of the arm portion 71. After accommodation, the hook-shaped portion 72 protrudes to its original position when the hook-shaped portion 72 reaches the position of the recessed engagement portion 18. Thus, simply pushing the casing frame 5 into the case body 1 from the lower side in the Z direction allows the locking portion 7 (the hook-shaped portion 72 of the locking portion 7) of the casing frame 5 to be locked to the engagement portion 18 of the case body 1.

Furthermore, in the embodiment, the first recess 55, which is recessed toward the inner periphery so as to surround the locking portion 7, is formed in a portion including the position of the locking portion 7 in the side wall 50. Consequently, when the arm portion 71 is pressed by the jig T or a similar tool, a space is secured for the arm portion 71 and the hook-shaped portion 72 to separate from the inner peripheral surface of the case body 1. This allows the hook-shaped portion 72 to move toward the first recess 55 when the arm portion 71 is pressed and deflects, thereby facilitating release of the hook-shaped portion 72 from the engagement portion 18.

Furthermore, in the embodiment, a portion at the base end of the arm portion 71 is the straight portion 73 formed linearly along the inner peripheral surface of the case body 1. This facilitates insertion of the jig T, such as a screwdriver, between the inner peripheral surface of the case body 1 and the locking portion 7 of the casing frame 5, enabling smooth removal of the casing frame 5.

Furthermore, in the embodiment, when the locking portion 7 is locked to the engagement portion 18, at least a portion of the locking portion 7 does not overlap with the bottom plate 51 and side wall 50 in plan view. Thus, since at least a portion of the locking portion 7 does not overlap with the bottom plate 51 and side wall 50 when viewed in plan from the back surface side, the jig T can be easily inserted from the back surface side without catching on the side wall 50 and the like. This allows the locking portion 7 to be pressed smoothly, thereby releasing the locked state where the hook-shaped portion 72 is locked to the engagement portion 18.

Furthermore, in the embodiment, the second recess 56 (see FIG. 7) is formed on the bottom plate 51 side of the side wall 50, and the locking portion 7 extends from the second recess 56. This ensures a gap between the peripheral wall 10 of the case body 1 and the base end of the locking portion 7, allowing the jig T to be inserted smoothly.

Furthermore, the bottom plate 51 of the embodiment has the hole 52 extending through the thickness direction (up and down in the Z direction). The module 3 is press-fitted to the casing frame 5. Therefore, attempting to remove the casing frame 5 from the case body 1 risks pulling the module 3 out with the casing frame 5. Since the shaft portion (e.g., winding stem) of the operating element 11 is inserted into the module 3 from the outside of the case body 1, pulling on the module 3 may damage such a shaft portion. In this regard, the presence of the hole 52 in the bottom plate 51 allows the module 3 to be held down through the hole 52 while performing the removal operation of the casing frame 5, enabling the casing frame 5 alone to be removed from the case body 1. This prevents damage to the shaft portion and the module 3.

Furthermore, the side wall 50 of the embodiment has the protrusions 57 protruding radially outward from the bottom plate 51, and the protrusions 57 are positioned substantially symmetrically with respect to the imaginary straight line L connecting the locking portion 7 and the center of the bottom plate 51. This allows forces applied to the case body 1 and the casing frame 5 to be distributed evenly when removing the casing frame 5 from the case body 1, facilitating smooth removal.

Furthermore, in the timepiece 100 including the casing frame 5 according to the embodiment, while it may be difficult to remove the casing frame 5 from the case body 1 by hand, the casing frame 5 can be relatively easily removed using the jig T or a similar tool. This allows the casing frame 5 to be easily removed for repairs or other necessary tasks when required, while preventing accidental ingestion or loss of parts in the module 3 by children or others.

Although the present invention has been described above with reference to a specific embodiment, it should be understood that the invention is not limited to this embodiment and may be modified in various ways without departing from the scope of the invention. For example, in the present embodiment, the casing frame 5 is illustrated as being substantially circular in plan view, but the shape of the casing frame 5 is not limited thereto. For example, the casing frame 5 may be rectangular or the like. Furthermore, the shape of the timepiece 100 including the casing frame 5 is not limited to the illustrated example and may be, for example, substantially circular in plan view or substantially elliptical in plan view.

Furthermore, for example, in the present embodiment, the engagement portion 18 of the case body 1 and the corresponding locking portion 7 of the casing frame 5 are illustrated as being provided on the 12 o'clock side of an analog timepiece. However, the positions where the engagement portion 18 and the locking portion 7 are provided are not limited thereto. For example, the engagement portion 18 and the locking portion 7 may be positioned on the 6 o'clock side or the 9 o'clock side of an analog timepiece. Furthermore, since the engagement portion 18 and the locking portion 7 are the portions used when removing the casing frame 5 from the case body 1, it is preferable to position the engagement portion 18 and the locking portion 7 at easily identifiable locations such as the 12 o'clock side, 6 o'clock side, 3 o'clock side, or 9 o'clock side, rather than at intermediate locations such as the 2 o'clock side or 5 o'clock side.

Furthermore, although the jig T in FIGS. 8 and 9 is depicted as a screwdriver, the jig T needs only to be insertable between the case body 1 and the locking portion 7 of the casing frame 5 and is not limited to a screwdriver.

Furthermore, the embodiment illustrates the casing frame 5 as being applied to the timepiece 100, which is a wristwatch, but the casing frame 5 is not limited to being applied to a wristwatch. The devices to which the casing frame 5 of the present invention can be applied include various timepieces, such as pocket watches that do not have a band. The casing frame 5 of the present invention can be widely applied to, for example, electronic devices such as various smartwatches and sports watches, as well as devices that acquire biological information such as heart rate and blood flow information in addition to time.

In the above, one or more embodiments of the present invention are described. However, the scope of the present invention is not limited thereto and includes the scope of the claims below and the scope of their equivalents.

What is claimed is:

1. A casing frame accommodatable within a case body, comprising:
a bottom plate;
a side wall erected from a peripheral edge of the bottom plate; and
a locking portion formed on an outer peripheral side of the side wall, the locking portion being lockable to an engagement portion formed on an inner peripheral surface of the case body, wherein,
when the locking portion is locked to the engagement portion, at least a portion of the locking portion protrudes obliquely relative to the inner peripheral surface of the case body and toward the inner peripheral surface of the case body.

2. The casing frame according to claim 1, wherein
the locking portion includes:
an arm portion that extends from the bottom plate, at least a portion of the arm portion being configured to protrude obliquely relative to the inner peripheral surface of the case body and toward the inner peripheral surface of the case body; and
a hook-shaped portion formed at a free end of the arm portion, and
at least the arm portion is elastically deformable.

3. The casing frame according to claim 1, wherein the side wall has a first recess formed in a portion that includes a position of the locking portion, the first recess being recessed toward an inner periphery of the side wall so as to surround the locking portion.

4. The casing frame according to claim 2, wherein a portion at a base end of the arm portion is a straight portion formed linearly along the inner peripheral surface of the case body.

5. The casing frame according to claim 1, wherein the bottom plate has a hole that extends through a thickness direction of the bottom plate.

6. The casing frame according to claim 1, wherein
the side wall has protrusions that protrude radially outward from the bottom plate, and
the protrusions are positioned symmetrically with respect to an imaginary straight line that connects the locking portion and a center of the bottom plate.

7. The casing frame according to claim 1, wherein, when the locking portion is locked to the engagement portion, at least a portion of the locking portion does not overlap with the bottom plate and the side wall in a plan view.

8. The casing frame according to claim 1, wherein
a second recess is formed on a bottom plate side of the side wall, and
the locking portion extends from the second recess.

9. A timepiece comprising the casing frame according to claim 1.

10. A case body capable of accommodating a casing frame, comprising:
a peripheral wall configured to surround an outer peripheral surface of the casing frame; and
an engagement portion formed on an inner peripheral side of the peripheral wall, the engagement portion being capable of locking a locking portion formed on an outer peripheral surface of the casing frame, wherein,
when the locking portion is locked to the engagement portion, at least a portion of the locking portion protrudes obliquely relative to an inner peripheral surface of the case body and toward the inner peripheral surface of the case body.

11. The case body according to claim 10, wherein
the locking portion includes:
an arm portion, at least a portion of the arm portion being configured to protrude obliquely relative to the inner peripheral surface of the case body and toward the inner peripheral surface of the case body; and
a hook-shaped portion formed at a free end of the arm portion,
at least the arm portion is elastically deformable,
the engagement portion formed on the inner peripheral surface of the case body is a recess, and
the hook-shaped portion protrudes into the engagement portion.

12. The case body according to claim 11, wherein a portion at a base end of the arm portion is a straight portion formed linearly along the inner peripheral surface of the case body.
